(19) United States
(12) Patent Application Publication
(10) Pub. No.: US 2023/0060879 A1
(43) Pub. Date: Mar. 2, 2023

(54) POWER TOOL AND ONE-HAND SAW

(71) Applicant: Nanjing Chervon Industry Co., Ltd., Nanjing (CN)

(72) Inventor: Zhaodi Ou, Nanjing (CN)

(21) Appl. No.: 17/879,035

(22) Filed: Aug. 2, 2022

(30) Foreign Application Priority Data
Aug. 25, 2021 (CN) 202110979022.7
Aug. 25, 2021 (CN) 202122018141.4

(51) Int. Cl. B23D 57/02

(52) U.S. Cl. CPC B23D 57/023

(57) ABSTRACT

A one-hand chainsaw includes a housing, a cutting device, and a battery coupling portion. The housing includes a main housing portion and a handle. The main housing portion is provided with a motor. The handle is disposed along a first straight line, the cutting device is disposed along a second straight line, an end of the cutting device is drivingly connected to the main housing portion, and the cutting device is driven by the motor to work and id formed by a guide plate and a saw chain disposed around the guide plate. The battery coupling portion extends along a third straight line from the main housing portion and is disposed below the handle. The battery coupling portion is configured to connect a battery pack.

### RELATED APPLICATION INFORMATION

This application claims the benefit under 35 U.S.C. § 119(a) of Chinese Patent Application No. CN 202110979022.7, filed on Aug. 25, 2021, and Chinese Patent Application No. CN 202122018141.4, filed on Aug. 25, 2021 which applications are incorporated herein by reference in their entirety.

### BACKGROUND

Generally, large power tools are more suitable for professional work processes, relatively large sizes of objects to be treated, or the like. At present, with the development of the economy, the demand for power tools in individual households is increasing. In addition, requirements of machining operations tend to be more and more refined, which also increases the demand for small and medium-sized power tools.

### SUMMARY

A one-hand chainsaw includes a housing, a cutting device, and a battery coupling portion. The housing includes a main housing portion and a handle, where the main housing portion is provided with a motor. The cutting device is disposed along a second straight line, where an end of the cutting device is drivingly connected to the main housing portion, and the cutting device is driven by the motor to work and formed by a guide plate and a saw chain disposed around the guide plate. The battery coupling portion extends from the main housing portion and is disposed below the handle, where the battery coupling portion is configured to connect a battery pack.

In some examples, the main housing portion includes a motor housing portion and a central portion which is disposed below the motor housing portion, where the motor housing portion is provided with a cavity for accommodating the motor, and the central portion is connected to the battery coupling portion.

In some examples, the handle includes a first end and a second end, where the first end is connected to the main housing portion, and the battery pack is disposed below the second end; and the second end is connected to the central portion through the battery coupling portion.

In some examples, the handle is disposed along a first straight line, and the motor is disposed along a third straight line, where an intersection of the third straight line and the second straight line is in the central portion, and an intersection of the first straight line and the third straight line is in the motor housing portion.

In some examples, the first straight line intersects with the second straight line, and an intersection of the first straight line and the second straight line is behind the main housing portion.

In some examples, a center of gravity of the one-hand chainsaw is in the handle and is not beyond a rear end of the handle.

In some examples, a ratio of maximum output power of the motor to the weight of the one-hand chainsaw is greater than or equal to 320 W/kg and less than or equal to 800 W/kg.

In some examples, a ratio of maximum output power of the motor to the volume of the one-hand chainsaw is greater than or equal to 0.5 W/cm³ and less than or equal to 10 W/cm³.

In some examples, the second straight line and the third straight line have a first intersection, and the third straight line and the first straight line have a second intersection, where a distance between the first intersection and the second intersection is greater than 0 and less than or equal to 80% of the height of the one-hand chainsaw.

In some examples, the one-hand chainsaw further includes a circuit board, where a first accommodating space is formed in the battery coupling portion, and the circuit board is disposed in the first accommodating space.

In some examples, the battery coupling portion is provided with an air inlet, and the motor housing portion is provided with an air outlet, where an airflow enters through the air inlet, passes the circuit board and the motor, and then flows out of the air outlet on the motor housing portion.

In some examples, the battery pack includes at least one lower end surface parallel to a working level, where the height of the lower end surface in an up-down direction is less than or equal to the height of a lower edge of the central portion in the up-down direction.

In some examples, an upper surface of the central portion is provided with a stopper portion protruding upward, and the stopper portion is spaced apart from the motor housing portion.

In some examples, the stopper portion is disposed along a fifth straight line inclining toward a direction away from the cutting device with respect to the up-down direction.

In some examples, an upper end of the motor housing portion is recessed downward to form a first holding groove, where a front end and a rear end of the first holding groove protrude, and a left end and a right end of the first holding groove form openings to communicate with an external space.

A power tool includes a housing, a cutting device, and a battery coupling portion. The housing includes a main housing portion and a handle, where the main housing portion is provided with a motor. The cutting device is disposed along a second straight line, where an end of the cutting device is drivingly connected to the main housing portion, and the cutting device is driven by the motor to work and formed by a guide plate and a saw chain disposed around the guide plate. The battery coupling portion extends from the main housing portion and is disposed below the handle, where the battery coupling portion is configured to connect a battery pack. The power tool has a total weight M when the battery pack is not connected to the power tool, where the total weight M is less than or equal to 2.5 kg.

In some examples, a ratio of maximum output power of the motor to the weight of the power tool is greater than or equal to 320 W/kg and less than or equal to 800 W/kg.

In some examples, a ratio of maximum output power of the motor to the volume of the power tool is greater than or equal to 0.5 W/cm³ and less than or equal to 10 W/cm³.

A power tool includes a housing, a cutting device, and a battery coupling portion. The housing includes a main housing portion and a handle, where the main housing portion is provided with a motor, the handle is disposed along a first straight line, and the motor is disposed along a third straight line. The cutting device is disposed along a second straight line, where an end of the cutting device is drivingly connected to the main housing portion, and the cutting device is driven by the motor to work and formed by a guide plate and a saw chain disposed around the guide plate. The battery coupling portion extends from the main housing portion and is disposed below the handle, where the battery coupling portion is configured to connect a battery pack. The second straight line and the third straight line have a first intersection, and the third straight line and the first straight line have a second intersection, where a distance between the first intersection and the second intersection is greater than 0 and less than or equal to 80% of the height of the power tool.

In some examples, the main housing portion includes a motor housing portion and a central portion which is disposed below the motor housing portion, where the motor housing portion is provided with a cavity for accommodating the motor, the central portion is connected to the battery coupling portion, the first intersection is in the central portion, and the second intersection is in the motor housing portion.

The present application has the beneficial effect that the power tool in the present application is suitable for holding with one hand, which provides good user experience, and the power tool has relatively high output power while having a relatively small volume and a relatively light weight, so that most objects can be cut with one hand in general use conditions.

### BRIEF DESCRIPTION OF DRAWINGS

FIG. 1 is a structural view of an example power tool;

FIG. 2 is a front view of a structure of the example power tool;

FIG. 3 is a top view of the structure of the example power tool;

FIG. 4 is a sectional view taken along plane A-A in FIG. 3;

FIG. 5 is a partial enlarged view of structure B in FIG. 1; and

FIG. 6 is a bottom view of the structure of the example power tool.

### DETAILED DESCRIPTION

A power tool will be described below in detail in conjunction with drawings and examples.

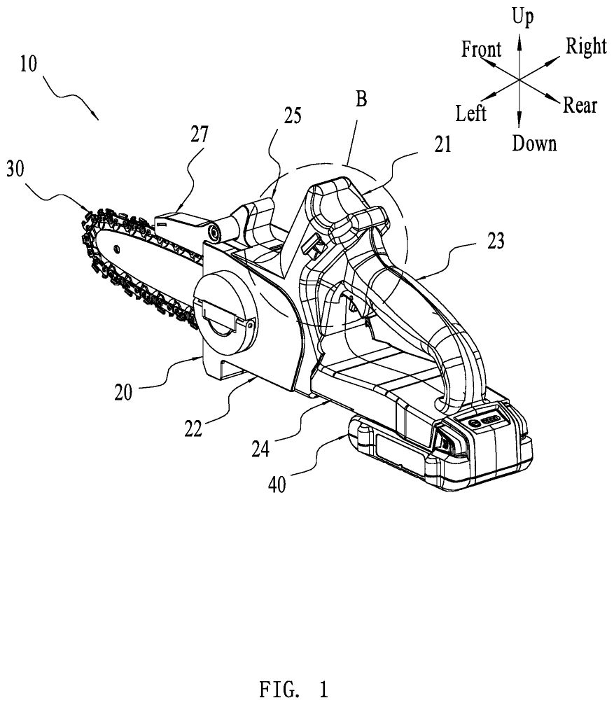

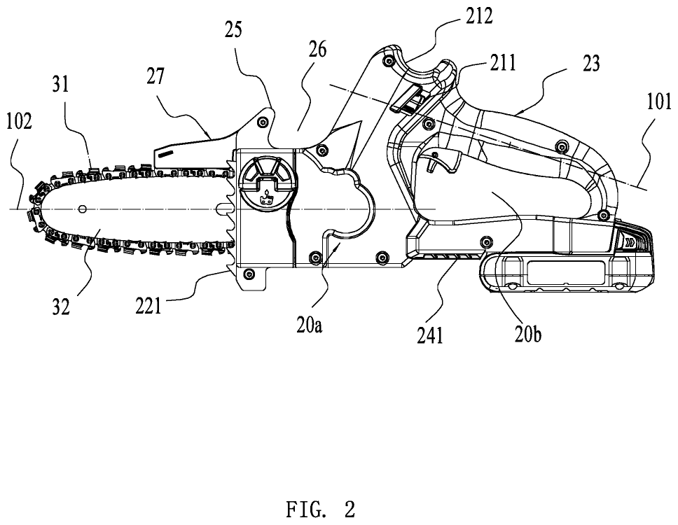

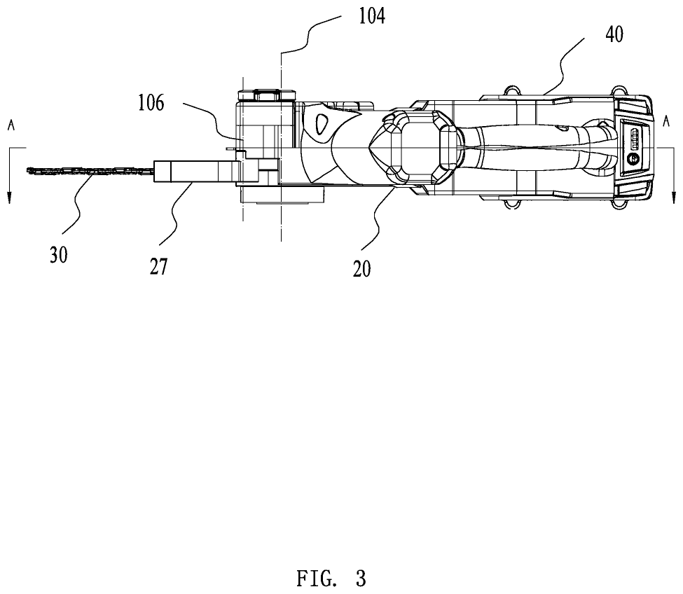

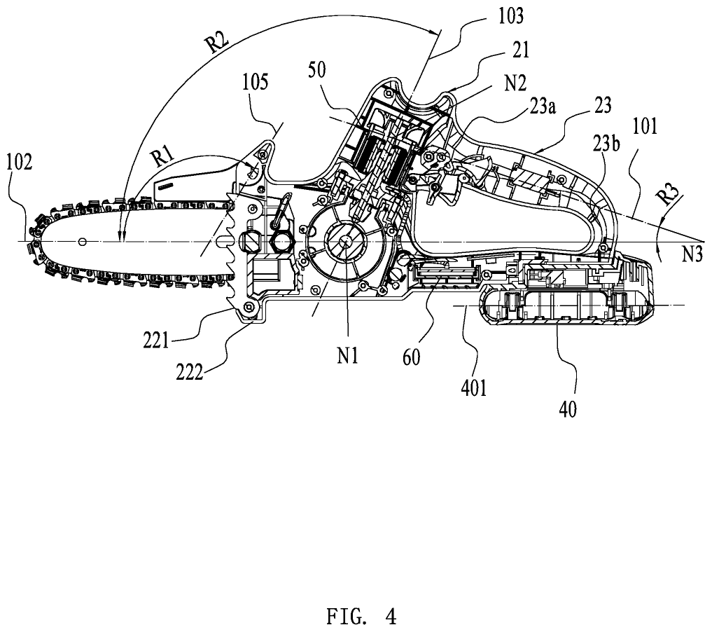

As shown in FIGS. 1 to 4, specifically, a power tool 10 in this example is a handheld one-hand chainsaw, and this example particularly relates to a chain saw suitable for holding with one hand. As shown in FIGS. 1 to 5, the power tool 10 includes a housing 20. The housing 20 includes a main housing portion 20a. The main housing portion 20a includes a motor housing portion 21 and a central portion 22 which is disposed below the motor housing portion 21. The housing 20 further includes a handle 23 and a battery coupling portion 24. It is to be noted that the holding with one hand in the present application refers to that a user may hold, in most working conditions, a handle with one hand to operate the one-hand chainsaw to work. However, it is to be understood that when the user holds the one-hand chainsaw with one hand for performing the operation, optionally, the user may hold another portion of the one-hand chainsaw with the other hand to assist in the operation. The one-hand chainsaw in this example does not limit the user to work with only one hand holding the one-hand chainsaw.

To facilitate the description of the technical solutions of the present application, the terms “up”, “down”, “front”, “rear”, “left” and “right” indicated by arrows in FIG. 1 are further defined. In this example, the terms “up”, “down”, “front”, “rear”, “left” and “right” are defined by using a state of the power tool 10 in FIG. 1 as an example.

The motor housing portion 21 is provided with a first accommodating cavity in which a motor 50 is disposed along a third straight line 103. The motor 50 drives, through a transmission device, a cutting device 30 to work. The cutting device 30 is disposed along a second straight line 102 and formed by a guide plate and a saw chain disposed around the guide plate. The central portion 22 is provided with a second accommodating cavity in which the transmission device and part of the cutting device 30 are disposed, so that most of the cutting device 30 extends out of the central portion 22 for performing a cutting operation.

The third straight line 103 and the second straight line 102 intersect at a first intersection N1, where the first intersection N1 is in the central portion. That is, the motor housing portion 22 and the cutting device 30 extend from the first intersection N1 of the central portion along the third straight line 103 and the second straight line 102, respectively. The third straight line 103 and the second straight line 102 form an included angle R2, where 90° ≤R2≤160°, and in some examples, 110° ≤R2≤150°. Thus, a center of gravity is closer to the rear handle and the cutting device is not hindered from working.

The handle 23 is disposed along a first straight line 101 and includes a first end 23a connected to the motor housing portion 21 and a second end 23b provided with a battery pack 40. The first straight line and the third straight line intersect at a second intersection N2, and the second straight line and the first straight line intersect at a third intersection N3. The second intersection N2 is in the motor housing portion 21, and the third intersection N3 is behind the main housing portion 20a. In other examples, the first straight line 101 may also be parallel to the second straight line 102, or the first straight line 101 and the second straight line 102 may also be in different planes, which is not limited herein. The second straight line 102 and the first straight line 101 form an included angle R3, where 0° ≤R3≤90°, and in some examples, 10° ≤R3≤60°. In a case where the second straight line 102 and the first straight line 101 form an included angle R3 of 0° or 90°, the handle 23 may be in the shape of a right angle, with two sides which form angles of 0° and 90° respectively with the first straight line 101. In this application, an intersection of two straight lines in this example may refer to a point formed by the two straight lines being arranged in a same plane and intersecting, or it may refer to a point formed by the intersection of the projections of two straight lines set in different planes on the paper surface respectively.

The main housing portion 20a, the handle 23 and the battery coupling portion 24 are connected in sequence to form a through hole 20b, and the through hole 20b is arranged for fingers of a user's hand to pass through when the handle 23 is held by the user's hand. The first end 23a of the handle 23 is separated from the battery coupling portion 24 and connected through the main housing portion 20a, and the second end 23b of the handle 23 is close to and connected with the battery coupling portion 24.

The preceding combination of the angles R2 and R3 can cause the center of gravity of the power tool 10 to be in the handle 23, and in particular, can cause the center of gravity of the power tool 10 to be close to the purlicue of the hand of the user for holding. Thus, optimal user experience is provided, and the user will not feel tired when the user holds the handle 23 for a long time. No matter whether the user holds the handle 23 with the arm drooping down normally or bending, the user has better experience.

The second intersection N2 is higher in height than the first intersection N1 in an up-down direction. A linear distance between the first intersection N1 and the second intersection N2 is greater than 0 and less than or equal to 80% of a height of the whole machine. In some examples, the linear distance between the first intersection N1 and the second intersection N2 is greater than 0 and less than or equal to 40% of the height of the whole machine. A target object of the power tool in the type of chain saws is generally lower in height than the shoulder of a human body and even the target object is lower in height than the elbow of the arm. Therefore, in most cases, it is not necessary to raise the power tool for performing the operation. For small and medium-sized chain saws, the position where the preceding structure is coupled to the battery pack allows the center of gravity to be in the handle or below the handle, so that when held by the hand, the power tool 10 applies a relatively small pressure on the hand, thereby improving the user experience.

The first straight line 101 and the third straight line 103 are located in the same plane, and the second straight line 102 is parallel or substantially parallel to the plane in which the first straight line 101 and the third straight line 103 are located. Further, the first straight line 101, the second straight line 102, and the third straight line 103 are located in the same plane. The parallelism in cutting the target object by the user and the balance of the power tool are ensured. In other examples, the third straight line 103 may be perpendicular to the plane in which the first straight line 101 is located, or the third straight line 103 and the first straight line 101 may be in different planes or intersect with each other.

The transmission device rotates about a fourth straight line 104 and transmits a drive to the saw chain 31. The fourth straight line 104 is perpendicular to a plane in which the cutting device is located, that is, the fourth straight line 104 is substantially perpendicular to the second straight line 102 or the third straight line 103. Specifically, the fourth straight line 104 passes the first intersection Ni or has an extremely short linear distance from the first intersection N1, that is, the first intersection Ni is at the rotation center of the transmission device.

The power tool 10 has a total weight M when the battery pack 40 is not mounted to the power tool 10. When M ≤2.5 kg, it may be considered that the power tool is operated by one hand. In this example, the motor 50 is a brushless motor and has a maximum continuous output power P. A ratio of the maximum output power P of the motor to the weight M of the power tool is greater than or equal to 320 W/kg and less than or equal to 800 W/kg. In some examples, the ratio of P to M is greater than or equal to 350 W/kg and less than or equal to 580 W/kg. When the battery pack 40 and the cutting device 30 are not mounted to the power tool 10, the power tool 10 has a weight M′. A ratio of the maximum output power P of the motor to the weight M′ of the power tool is greater than or equal to 350 W/kg and less than or equal to 900 W/kg. In some examples, the ratio of P to M′ is greater than or equal to 400 W/kg and less than or equal to 650 W/kg. The power tool 10 without the cutting device 30 and the battery pack 40 has a volume V. A ratio of the maximum output power P of the motor to the volume V of the power tool is greater than or equal to 0.5 W/cm³ and less than or equal to 10 W/cm³. In some examples, the ratio of P to V is greater than or equal to 1 W/cm³ and less than or equal to 6 W/cm³. The power tool has relatively high output power while having a relatively small volume and a relatively light weight, so that most objects can be cut with one hand in general use conditions.

The battery coupling portion 24 extends from the main housing portion 20a and is disposed below the handle 23, and the battery coupling portion 24 extends toward the rear of the main housing portion 20a along a first direction. Specifically, in this example, the first direction is substantially parallel to the second straight line 102. In this example, the second end of the handle 23 is connected to the central portion 22 through the battery coupling portion 24, and the battery pack 40 is connected to the battery coupling portion 24. In other examples, the second end of the handle 23 may not be connected to the battery coupling portion. Specifically, the battery pack 40 and the battery coupling portion 24 are detachably connected to each other, and the battery coupling portion 24 has a third receiving cavity disposed in front of the battery pack and a receiving slot for connecting the battery pack 40. The battery pack 40 is mounted to the receiving slot on the battery coupling portion 24 along a mounting plane 401. In this example, the mounting plane 401 is parallel to the working level so that the power tool 10 can be placed on any plane according to a lower surface of the battery pack 40. The working level is a plane perpendicular to the up-down direction. The mounting plane 401 is substantially parallel to the second straight line 102 or forms an included angle with the second straight line 102, where the intersection of the mounting plane 401 and the second straight line 102 is in front of the power tool, and the included angle is less than or equal to 15°. The preceding structure enables the power tool to be stably placed on a certain plane and the cutting device will not damage the plane. A projection of the battery pack 40 in the working level is at least partially behind a projection of the handle in the preceding plane. In other examples, the included angle between the mounting plane 401 and the second straight line 102 may be greater than 15°. In this case, most of the battery pack 40 is behind the handle 23. Alternatively, the battery pack is mounted in another manner as long as it is ensured that the battery pack is provided with at least one end surface parallel to the level, the at least one end surface facing a lower side of the power tool.

In this example, the central portion 22 is further provided with a bumper spike 221, and a mounting portion 222 to which one end of the bumper spike 221 is mounted is disposed below the central portion 22. The bumper spike 221 has a sharp toothed structure on one side which faces the cutting device 30. Additionally, the bumper spike 221 partially protrudes from the central portion 22 and is partially in the central portion 22. The toothed structure of the bumper spike 221 is used for cutting a workpiece to ensure that the power tool cuts downward smoothly. Two ends of the bumper spike 221 are connected to a connection mechanism in the central portion 22, and a lower end of the bumper spike 221 is connected to the mounting portion 222. The mounting portion 222 is a housing portion protruding downward, and a lower end surface of the mounting portion 222 is parallel to a lower end surface of the battery pack 40. Alternatively, the lower end surface of the mounting portion 222 is slightly higher in height than the lower end surface of the battery pack 40 in the up-down direction so that an included angle between the working level and a line connecting the two end surfaces is less than 6°, thereby ensuring that the cutting device 30 does not touch a working surface when the power tool 10 is placed.

In other examples, the circuit board 60 may be disposed at a lowermost end of the central portion 22. In this case, the battery coupling portion 24 is only used for connecting the battery pack so that the length of the power tool 10 in a front-rear direction and the length of the handle 23 can be further reduced, and the height of the lower end surface of the battery pack is more proximate to the height of the lower end surface of the central portion.

The circuit board 60 is disposed in the third receiving cavity to receive signals or output signals to other structures such as the motor or a switch assembly. The battery coupling portion 24 is provided with an air inlet 241 in the vicinity of the circuit board 60, where the air inlet 241 may be disposed on an upper portion or a lower portion of the battery coupling portion 24. A mounting slot 242 for mounting the battery pack 40 is disposed behind the air inlet 241. The mounting slot 242 faces the rear of the power tool 10 so that the battery pack 40 is inserted from the rear of the battery coupling portion 24.

A fan is disposed behind the motor 50 and rotates coaxially with the motor 50. In other examples, no additional fan may be provided, where a fan of the motor may be used or, a fan is disposed between the motor 50 and the transmission device, thereby improving a heat dissipation effect. The motor housing portion 21 is provided with an air outlet 211, and an airflow enters through the lower air inlet 241, passes the circuit board 60 and the motor 50, and then flows out of the air outlet 211 of the motor housing portion 21.

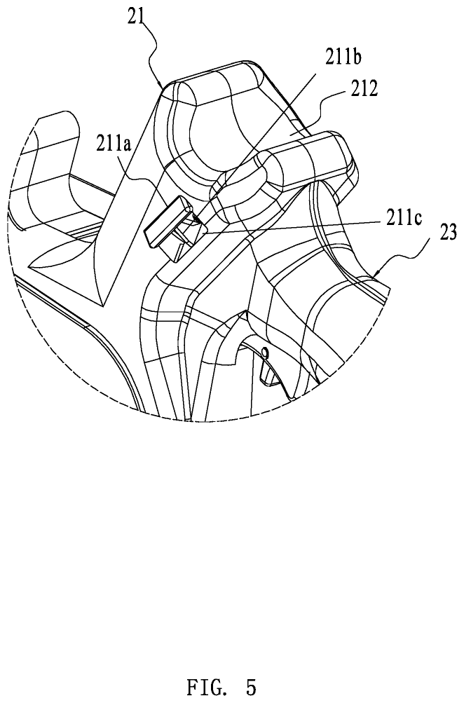

As shown in FIG. 5, in this example, at least one air outlet 211 is disposed on a peripheral side of the motor housing portion. In this example, one air outlet 211 is disposed on each of the left and right sides of the motor housing portion 21. An air deflector 211a is disposed on one side of the air outlet 211. Particularly, the air deflector 211a is disposed in the front of the air outlet 211. The air deflector 211a has an incline protruding outward and inclining along a direction away from the cutting device 30 so as to guide the outgoing airflow to the rear of the power tool 10, thereby avoiding the case where the airflow causes cutting scraps to fly upward. The housing at the air outlet 211 also forms an incline 211c inclining in the same direction as the air deflector 211a. The air outlet 211 is further provided with a partition 211b which divides the air outlet 211 into multiple small holes, thereby improving safety when the area of the air outlet 211 is increased.

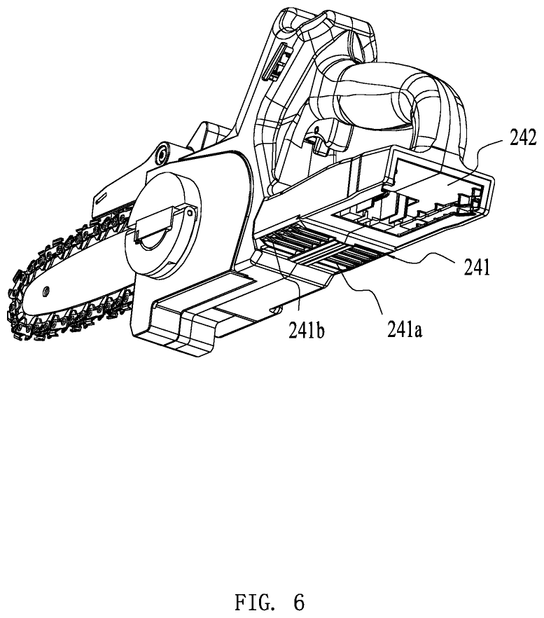

As shown in FIG. 6, in this example, the air inlet 241 is configured to be a region covering a bottom surface and part of side surfaces of the third receiving cavity. The housing of the battery coupling portion 24 in the region of the air inlet 241 has a lattice structure including multiple through holes. The air inlet 241 includes several grilles 241a. The grilles 241a are configured to be inclined such that airflow enters from the rear of the air inlet 241. Two ends of each grille 241a have inclines inclining upward so that the region of the air inlet 241 extends all the way to sides of the battery coupling portion 24.

An upper end of the motor housing portion 21 is recessed downward to form a first holding groove 212. A front end and a rear end of the first holding groove 212 protrude, and a left end and a right end of the first holding groove 212 form openings to communicate with an external space. The power tool in this example is mainly configured to be held with one hand. However, for a special user or a special use scenario (for example, the user has insufficient strength, needs to use the power tool transversely, or needs to keep a steadier cutting), an auxiliary holding part, in addition to a main holding part, is typically necessary for the other hand of the user to hold with a force. A specialized auxiliary handle is typically disposed in a general large power tool. However, in the small or medium-sized power tool involved in the present application, an auxiliary handle disposed generally needs a large occupied space. The small or medium-sized power tool is not heavy and suitable for a one-hand operation in most use conditions. In this case, the setting of auxiliary handle puts the incidental before the fundamental, and increases the manufacturing cost, the occupied space, the weight, and the like. The first holding groove 212 in this example can be used for auxiliary holding in a special condition. The user holds a sidewall of the motor housing portion 21 by a palm, with a thumb placed in the first holding groove 212, so that the user has a good holding feel.

The central portion 22 is provided with a stopper portion 25 protruding along a fifth straight line 105, where the stopper portion 25 is in front of the motor housing portion 21, and is spaced apart from the motor housing portion 21. The fifth straight line 105 inclines toward a direction away from the cutting device with respect to the up-down direction. That is, the fifth straight line 105 and the second straight line 102 form an included angle R1, where R1 >90°. A second holding groove 26 is formed by the stopper portion 25, an upper surface of the central portion 22 and a sidewall of the motor housing portion 21. The user puts a side of the palm in the second holding groove 26 or holds the second holding groove 26 in other manners. The stopper portion 25 is used for stopping the hand for auxiliary holding from further sliding downward so as to prevent the palm from sliding downward and being damaged by the cutting device in some conditions, thereby improving the safety of the tool.

The housing 20 includes a shield 27 disposed above the cutting device 30 and connected to the housing of the central portion 22, where the shield 27 rotates about a sixth straight line 106. Specifically, the length of the shield 27 in the front-rear direction is less than or equal to one-half of the length of the portion of the cutting device 30 extending from the central portion 22. The shield 27 is pivoted in the central portion 22 or directly pivoted to the stopper portion 25 to rotate relative to the central portion 22. A return spring is disposed in the shield 27 for return of the lifted shield 27.

The handle 23 further includes the switch assembly disposed below the handle. Specifically, the switch assembly is disposed at the intersection of the handle 23 and the motor housing portion 21. A mechanical structure of the switch assembly is disposed in the handle 23, and a related connection circuit is connected to the circuit board along the handle 23 and the battery coupling portion 24.

The above illustrates and describes basic principles, main features, and advantages of the subject power tool. It is to be understood by those skilled in the art that the preceding examples do not limit the present application in any form, and technical solutions obtained by means of equivalent substitutions or equivalent transformations fall within the scope of the present application.

What is claimed is:

1. A one-hand chainsaw, comprising:
a housing comprising a main housing portion and a handle;
a motor provided in the main housing portion;
a cutting device comprising a guide plate and a saw chain disposed around the guide plate, wherein the cutting device comprises a guide plate and a saw chain disposed around the guide plate, an end of the cutting device is connected to the main housing portion, and the cutting device is driven by the motor to work; and
a battery coupling portion extending from the main housing portion and disposed below the handle, wherein the battery coupling portion is configured to connect a battery pack.

2. The one-hand chainsaw according to claim 1, wherein the main housing portion comprises a motor housing portion and a central portion which is disposed below the motor housing portion, the motor housing portion is provided with a cavity for accommodating the motor, and the central portion is connected to the battery coupling portion.

3. The one-hand chainsaw according to claim 2, wherein the handle comprises a first end and a second end, the first end is connected to the main housing portion, the battery pack is disposed below the second end, and the second end is connected to the central portion through the battery coupling portion.

4. The one-hand chainsaw according to claim 3, wherein the handle is disposed along a first straight line, the cutting device is disposed along a second straight line, the motor is disposed along a third straight line, an intersection of the third straight line and the second straight line is in the central portion, and an intersection of the first straight line and the third straight line is in the motor housing portion.

5. The one-hand chainsaw according to claim 4, wherein the first straight line intersects with the second straight line and an intersection of the first straight line and the second straight line is behind the main housing portion.

6. The one-hand chainsaw according to claim 5, wherein the second straight line and the third straight line have a first intersection, the third straight line and the first straight line have a second intersection, and a distance between the first intersection and the second intersection is greater than 0 and less than or equal to 80% of a height of the one-hand chainsaw.

7. The one-hand chainsaw according to claim 1, wherein a center of gravity of the one-hand chainsaw is in the handle and is not beyond a rear end of the handle.

8. The one-hand chainsaw according to claim 1, wherein a ratio of maximum output power of the motor to a weight of the one-hand chainsaw is greater than or equal to 320 W/kg and less than or equal to 800 W/kg.

9. The one-hand chainsaw according to claim 1, wherein a ratio of maximum output power of the motor to a volume of the one-hand chainsaw is greater than or equal to 0.5 W/cm³ and less than or equal to 10 W/cm³.

10. The one-hand chainsaw according to claim 1, further comprising a circuit board and wherein a first accommodating space is formed in the battery coupling portion and the circuit board is disposed in the first accommodating space.

11. The one-hand chainsaw according to claim 10, wherein the main housing portion comprises a motor housing portion and a central portion which is disposed below the motor housing portion, the motor housing portion is provided with a cavity for accommodating the motor, the central portion is connected to the battery coupling portion, the battery coupling portion is provided with an air inlet, the motor housing portion is provided with an air outlet, and an airflow enters through the air inlet, passes the circuit board and the motor, and then flows out of the air outlet on the motor housing portion.

12. The one-hand chainsaw according to claim 2, wherein the battery pack comprises at least one lower end surface parallel to a working level when the battery pack is coupled to the battery coupling portion and a height of the lower end surface in an up-down direction is less than or equal to a height of a lower edge of the central portion in the up-down direction.

13. The one-hand chainsaw according to claim 2, wherein an upper surface of the central portion is provided with a stopper portion protruding upward and the stopper portion is spaced apart from the motor housing portion.

14. The one-hand chainsaw according to claim 13, wherein the stopper portion extends away from the cutting device along a fifth straight line inclined with respect to the up-down direction.

15. The one-hand chainsaw according to claim 2, wherein an upper end of the motor housing portion is recessed downward to form a first holding groove, a front end and a rear end of the first holding groove protrude, and a left end and a right end of the first holding groove form openings to communicate with an external space.

16. A power tool, comprising:
a housing comprising a main housing portion and a handle;
a motor provided in the main housing portion;
a cutting device comprising a guide plate and a saw chain disposed around the guide plate, wherein an end of the cutting device is connected to the main housing portion, and the cutting device is driven by the motor to work; and
a battery coupling portion extending from the main housing portion and disposed below the handle;
wherein the battery coupling portion is configured to connect a battery pack, the power tool has a total weight M when the battery pack is not connected to the power tool, and the total weight M is less than or equal to 2.5 kg.

17. The power tool according to claim 16, wherein a ratio of maximum output power of the motor to a weight of the power tool is greater than or equal to 320 W/kg and less than or equal to 800 W/kg.

18. The power tool according to claim 17, wherein a ratio of maximum output power of the motor to a volume of the power tool is greater than or equal to 0.5 W/cm³ and less than or equal to 10 W/cm³.

19. A power tool, comprising:
a housing comprising a main housing portion and a handle disposed along a first straight line;
a cutting device disposed along a second straight line, wherein an end of the cutting device is connected to the main housing portion and the cutting device comprises a guide plate and a saw chain disposed around the guide plate;
a motor configured to drive the cutting device to work disposed in the main housing portion along a third straight line; and
a battery coupling portion extending from the main housing portion and disposed below the handle, wherein the battery coupling portion is configured to connect a battery pack;
wherein the second straight line and the third straight line have a first intersection, the third straight line and the first straight line have a second intersection, and a distance between the first intersection and the second intersection is greater than 0 and less than or equal to 80% of a height of the power tool.

20. The power tool according to claim 19, wherein the main housing portion comprises a motor housing portion and a central portion which is disposed below the motor housing portion, the motor housing portion is provided with a cavity for accommodating the motor, the central portion is connected to the battery coupling portion, the first intersection is in the central portion, and the second intersection is in the motor housing portion.
